(19) United States
(12) Patent Application Publication
(10) Pub. No.: US 2021/0073869 A1
(43) Pub. Date: Mar. 11, 2021

(54) SYSTEMS AND METHODS OF REAL-TIME BIDDING FOR DIGITAL-OUT-OF-HOME ADVERTISING UNITS

(71) Applicant: Kubient Inc., New York, NY (US)

(72) Inventor: Christopher M. Andrews, New York, NY (US)

(73) Assignee: Kubient Inc., New York, NY (US)

(21) Appl. No.: 17/017,481

(22) Filed: Sep. 10, 2020

Related U.S. Application Data
(60) Provisional application No. 62/898,286, filed on Sep. 10, 2019.

(51) Int. Cl. G06Q 30/02; G06Q 30/08

(52) U.S. Cl. CPC G06Q 30/0275; G06Q 30/08

(57) ABSTRACT

Embodiments of the present invention provide for real-time bidding of DOOH advertising units. The systems and methods provide for an API associated with at least one DOOH display, wherein the API is configured to receive a bid request indicating an available advertising unit from the at least one DOOH display, provide the bid request to at least one buyer; and receive a bid response from the at least one buyer, wherein the bid response includes content to be played at the at least one DOOH display.

### CROSS-REFERENCE TO RELATED APPLICATION

This application claims the benefit of U.S. Provisional Patent Application No. 62/898,286, which was filed on Sep. 10, 2019 and is incorporated by reference in its entirety.

### FIELD OF THE INVENTION

The present disclosure relates to systems and methods of real-time bidding for digital-out-of-home (DOOH) advertising units.

### BACKGROUND OF THE INVENTION

DOOH advertising corresponds to advertising that occurs in public venues, e.g., static and digital billboards/signage. Unlike traditional digital advertising (e.g., websites, mobile apps, etc.), there currently isn't an effective way of buying and selling available DOOH advertising units in real time. As such, it would be desirable to have systems and methods that could overcome these and other deficiencies of known systems.

### SUMMARY OF THE INVENTION

Embodiments of the present invention relate to systems and methods for real-time bidding of DOOH advertising units. In particular, embodiments of the present invention transform the DOOH buying and selling process into a real-time programmatic transaction.

According to an embodiment, a system for real-time bidding of DOOH advertising units can include: an application programming interface (API) associated with at least one DOOH display, wherein the API is configured to: receive a bid request from the at least one DOOH display, wherein bid request is associated with an available advertising unit; provide the bid request to at least one RTB exchange; and receive a bid response from the at least one RTB exchange, wherein the bid response includes content to be played at the at least one DOOH display.

According to another embodiment, a method for real-time bidding of DOOH advertising units can include: generating, with at least one DOOH display, a bid request, wherein bid request is associated with an available advertising unit; receiving, with an API associated with the at least one DOOH display, the bid request; providing, with the API, the bid request to at least one RTB exchange; and receiving, with the API, a bid response from the at least one RTB exchange, wherein the bid response includes content to be played at the at least one DOOH display.

Further, embodiments of the present invention can provide the following advantages: (i) allow for RTB omni-channel digital marketing campaigns across all channels including DOOH, desktop web, mobile web, mobile in-app, social platforms, email, etc., (ii) ensure that specific audiences will be marketed to at the right time on the right channel with the right message, and (iii) allow brand managers to see true attribution, insights, analytics and detailed raw data in real-time in the proof-of-play dataset from their purchase of a single DOOH advertising unit.

These and other advantages will be described more fully in the following detailed description.

### BRIEF DESCRIPTION OF THE DRAWINGS

Some aspects of the disclosure are herein described, by way of example only, with reference to the accompanying drawings. With specific reference now to the drawings in detail, it is stressed that the particulars shown are by way of example and are for purposes of illustrative discussion of embodiments of the disclosure. In this regard, the description, taken with the drawings, makes apparent to those skilled in the art how aspects of the disclosure may be practiced.

FIG. 1 depicts a system for real-time bidding of DOOH advertising units according to an exemplary embodiment of the invention.

FIG. 2 depicts the inventor & decision management system in FIG. 1 according to an exemplary embodiment of the invention.

FIG. 3 depicts the supply-side platform in FIG. 2 according to an exemplary embodiment of the invention.

FIG. 4 depicts the data analytics system in FIG. 2 according to an exemplary embodiment of the invention.

### DETAILED DESCRIPTION

This description is not intended to be a detailed catalog of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. In other instances, well-known structures, interfaces, and processes have not been shown in detail in order not to unnecessarily obscure the invention. It is intended that no part of this specification be construed to affect a disavowal of any part of the full scope of the invention. Hence, the following descriptions are intended to illustrate some particular embodiments of the disclosure, and not to exhaustively specify all permutations, combinations and variations thereof.

Unless explicitly stated otherwise, the definition of any term herein is solely for identification and the reader's convenience; no such definition shall be taken to mean that any term is being given any meaning other than that commonly understood by one of ordinary skill in the art to which this disclosure belongs, unless the definition herein cannot reasonably be reconciled with that meaning. Further, in the absence of such explicit definition, all technical and scientific terms used herein have the same meaning as commonly understood by one of ordinary skill in the art to which this disclosure belongs. The terminology used in the description of the disclosure herein is for the purpose of describing particular embodiments only and is not intended to be limiting of the disclosure.

Unless the context indicates otherwise, it is specifically intended that the various features of the disclosure described herein can be used in any combination. Moreover, the present disclosure also contemplates that in some embodiments of the disclosure, any feature or combination of features set forth herein can be excluded or omitted.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

As used in the description of the disclosure and the appended claims, the singular forms “a”, “an”, and “the” are intended to include the plural forms as well, unless the context clearly indicates otherwise.

As used herein, “and/or” refers to and encompasses any and all possible combinations of one or more of the associated listed items, as well as the lack of combinations when interpreted in the alternative (“or”).

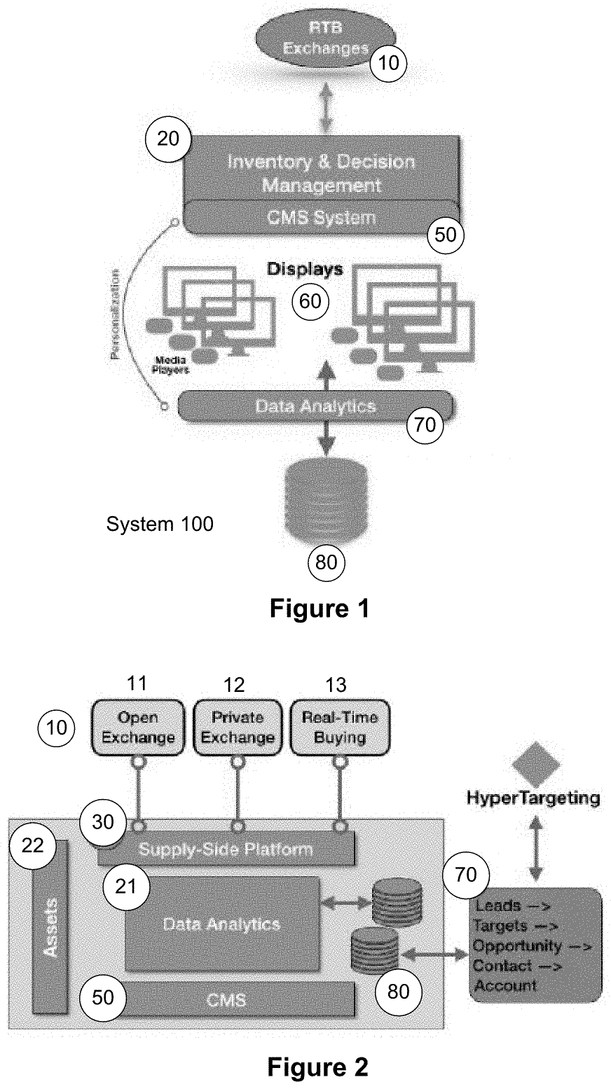

FIG. 1 depicts a system for real-time bidding of DOOH advertising units according to an exemplary embodiment of the invention. As depicted in the figure, a system 100 can include a plurality of real-time bidding (RTB) exchanges 10, an inventory & decision management system (IDMS) layer 20, a content management system (CMS) 50, a plurality of DOOH displays 60, a data analytics system 70, and a plurality of datasets 80. According to an embodiment, DOOH manufacturers each have a CMS system 50 to control the content of each of the DOOH displays 60. The IDMS layer 20 is configured to interface between the DOOH manufacturer's CMS system 50 and the plurality of RTB exchanges 10, thereby enabling the DOOH manufacturer to become a new publisher on the plurality of RTB exchanges 10. Further, the IDMS layer 20 is also configured to (i) know, track, and manage all of the advertising units at the DOOH display 60 by time-of-day and (ii) facilitate the application of data analytics 70, e.g., business rules and logic, to each RTB trade.

FIG. 2 depicts the IDMS layer 20 in more detail. As depicted in the figure, the IDMS layer 20 includes a supply-side platform (SSP) 30, a data analytics layer 21, and an asset management layer 22. The IDMS layer 20 is configured to interface with a DOOH manufacturer's CMS system 50, as well as with the data analytics system 70, e.g., via a plurality of datasets 80. Further, the plurality of RTB exchanges 10 can include an open exchange 11, a private exchange 12, and/or a real-time buying exchange 13. According to an embodiment, the SSP 30 is configured to interface with the plurality of RTB exchanges 10 in order to make the DOOH manufacturer's advertising inventory available to potential buyers on the plurality of RTB exchanges 10. In this regard, the SSP 30 can connect to the plurality of RTB exchanges 10 via a broker. The data analytics layer 21 is configured to capture all data in and out of the SSP 30. For example, the data analytics layer 21 is configured to collect data from each DOOH display 60 at their time of use. Further, the data analytics layer 21 is configured to interface with the data analytics system 70 in order to apply business rules and logic to each RTB trade. According to an embodiment, the data analytics system 70 can be located at each DOOH display 60, at the CMS system 50, and/or at a remote server. Further, the asset management layer 22 is configured to expand the CMS system 50's ability to handle traditional digital marketing and advertising assets in non-RTB bid requests. According to an embodiment, the assets can be static (e.g., billboards), animated (e.g., scrolling message, GIF file, etc.), or video (e.g., partial and full-screen). In this regard, the animated and video assets specifications can be provided by the individual DOOH device. For example, full-screen assets can play for one of 10, 15, 30, or 60 seconds. Further, the assets can also be one of emoji advertisements, 360-degree image and video advertisements, virtual reality advertisements, and augmented reality advertisements.

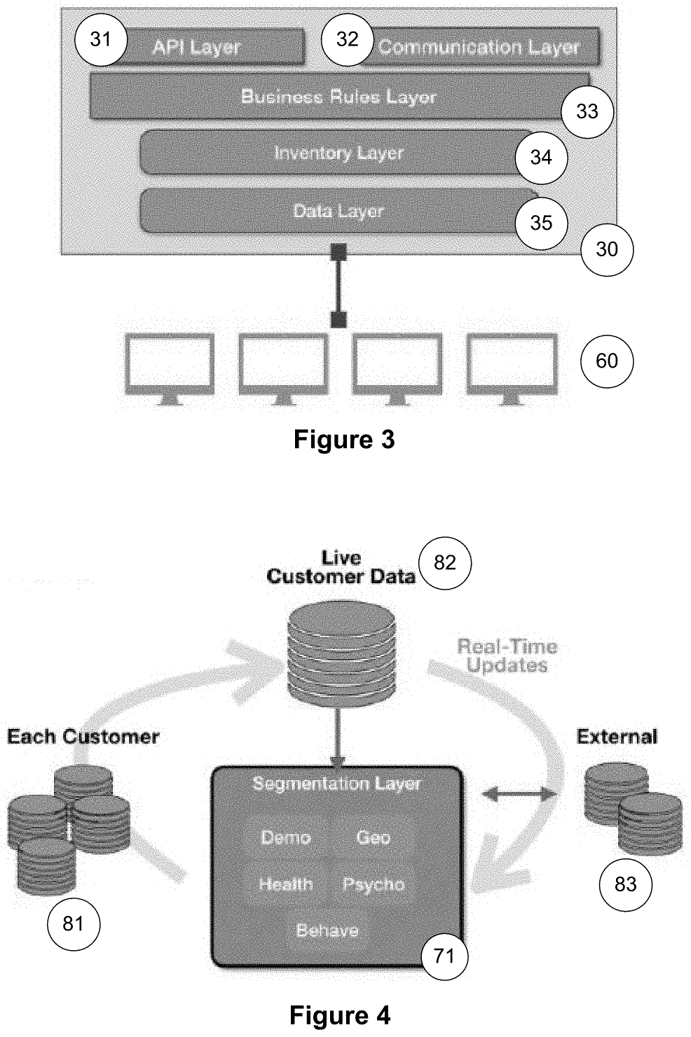

FIG. 3 depicts the SSP 30 in more detail. As depicted in the figure, the SPP 30 can include an application programming interface (API) layer 31, a communications layer 32, a business rules layer 33, an inventory layer 34, and a data layer 35. According to an embodiment, the API layer 31 is configured to provide the specifications required for the SSP 30 to interface with the plurality of RTB exchanges 10. According to an embodiment, the API layer 31 is configured to implement traditional IAB standards for technology guidelines and implementation, e.g., JSON, XML, etc. Further, the communications layer 31 is configured to send and receive different types of communications to individuals interacting and/or viewing the DOOH displays 60. This data can be used in conjunction with cookies, pixels, polygon/geofencing, etc., to track the individual's device, and capture as much data on the individual and the device at the proof-of-play. The business rules layer 32 is configured to manage all available inventory by pre-defined business needs and variable business requirements. For example, a pre-defined rule can be that any questionable content or buyers will always be excluded from being able to buy and place an ad. Further, a variable business rule can be that if Company A has purchased advertising inventory on a particular DOOH display 60 for X day/time, then Company B's ads cannot be placed and/or sold around the same time. The inventory layer 34 can be used to track and manage all available advertising unit inventory by device and publisher. According to an embodiment, the demographic and geographic data of the individual viewing the DOOH display 60 can be correlated with the device and publisher data in order to obtain higher pricing for the available advertising unit. The data layer 35 is configured to collect data from each DOOH display 60 at their time of use. According to an embodiment, the following can be collected from each DOOH display 60 (in real-time or as close to real-time as possible): proof of play, play time of day, physical location of device (e.g., city, state, zip code, location in the store, etc.), type of store device located (e.g., vertical market), whether or not someone is looking or walking by, whether or not someone is in front of the device (as well as genders and ages of those people), and number of eyeballs/impressions. Further, the data layer 35 is also configured to collect data associated with a particular bid, such as client information, brand information, industry information, price of winning bid, time of each bid, as well as where the bids came from, e.g., exchange, media company/agency, location (e.g., U.S., U.K., Germany), etc.

FIG. 4 depicts data analytics system 70 in more detail. As depicted in the figure, based on first, second, and third datasets 81, 82, and 83, respectively, a segmentation layer 71 can develop a hyper-targeting strategy that determines the best way of reaching out to a particular individual, e.g., DOOH, desktop web, mobile web, mobile in-app, social platforms, email, etc. According to an embodiment, the hyper-targeting strategy can be performed at the data analytics system 70. According to an embodiment, the datasets 81, 82, and 83 can be one of raw datasets, cubes of data, first party opted-in data, new audience profile look-alikes, and/or de-identified and aggregated datasets. In this regard, the first dataset 81 can correspond to historical data about first-party data, the brand, or the individual stored by the data analytics system 70, the second dataset 82 can correspond to live data about the individual provided by the DOOH displays 60 (e.g., device data), and the third dataset 83 can correspond to other data about the individual provided by a third-party (e.g., demographic data). The segmentation layer 71 can retrieve a number of relevant data from the first, second, and third datasets 81, 82, and 83. For example, the segmentation layer 71 can retrieve demographic data (e.g., race, ethnicity, gender, date of birth, zodiac sign, political affiliation, voting propensity, religion and/or religious observance, level education and corresponding degrees, Greek life affiliation, individual income, family income, marital status, spouse name, size of family, family member data, occupation data, professional affiliations, etc.), geographic data (e.g., address), health data (e.g., healthcare providers, telemedicine use, medical insurance details, dental insurance details, vision insurance details, life insurance details, body-mass index data, propensity for working out, hobbies, heart rate, blood pressure, propensity for healthy living, type of diet, etc.), psychographic data (e.g., lifestyle, values, social class, self-promoter traits, personality, mental health, and sexual preference, etc.), and behavioral data (e.g., brand usage, brand loyalties, brand awareness, brand knowledge, purchase patterns, propensity for email use, propensity for phone use, propensity for mobile device use, propensity for SMS use, propensity for mail use, propensity for tablet use, propensity for laptop use, propensity for desktop use, propensity for social media, shopping propensity, shopping behavior, etc.). Further, based on the above segmentation layer 71, a segmentation map for each known audience, e.g., leads, can be generated. In this regard, the audience segmentation mapping can be used to build new customer lists based on look-alike profiles of individuals to target/re-target during the execution of the RTB campaign. According to an embodiment, an audience can be determined based on at least one of relevant names, relevant email addresses, relevant phone numbers, relevant device IDs, and relevant IP addresses.

Further, according to an embodiment, data analytics can be performed based on the particular client, brand and/or location. In particular, the data analytics can provide at least one of: impressions served, domains served, click-through rate, conversions, and return on investment (ROI).

According to an embodiment, a method for using the system 100 by DOOH device manufacturers/publishers and potential advertisers/programmatic buyers is described below. First, the DOOH device manufacturer/publisher can generate a bid request for the available advertisement unit that can include various pieces of data, such as the DOOH advertising unit's IP, demographic information, location, venue type, physical dimensions, and more. According to an embodiment, the bid request can be provided in JSON format. According to another embodiment, the bid request can be provided in another industry standard format, e.g., XML, etc. Further, the bid request can include a number of extensions corresponding to data that is unique to the DOOH transactions. For example, the bid request can include an object “bid request” extension for the DOOH display 60. This extension can include an attribute corresponding to the estimated timeframe for when the advertisement will be displayed on the DOOH display 60. The bid request can also include object “impression” extensions. These extensions can contain an attribute corresponding to an expected number of visitors exposed to the DOOH display 60. Each impression can be multiplied with this number, so that the advertiser can be charged per number of estimated views. The bid request can also include an object “banner” extension. This extension can include the following attributes: dots per inch (DPI) information about the DOOH display 60 screen, exposure time of the advertisement (e.g., how long the advertisement will be shown before moving to the next advertisement), and the width and height of the DOOH display 60 screen. The bid request can also include an object “device” extension. This extension can include an attribute corresponding to the type of venue the DOOH display 60 is located in. For example, the venue can be one of an airport, ATM, bar, bulletin, bus, café, restaurant, cinema, convenience store, office, ferry, gas station, golf course, gym, hospital, hotel, kiosk, mall, billboard, newsstand, poster, train stop, salon, sports arena, subway, taxi, university, etc. According to an embodiment, the bid request can be implemented using the OpenRTB 2.5 standard and, therefore, the extensions can be added to the existing OpenRTB 2.5 specifications in order to accommodate the above additional information.

The generated bid request is then sent to the RTB exchanges 10 via the API 31. The RTB exchanges 10 can then submit the bid request and corresponding data to a plurality of advertisers/programmatic buyers, thereby allowing the advertisers/programmatic buyers to submit their bids, in real-time, for the available DOOH advertising unit. Assuming a suitable advertiser/programmatic buyer is found, the RTB exchanges 10 can send a bid response from the advertiser/programmatic buyer with the winning bid to the DOOH device manufacturer/publisher's CMS system 50. However, if there are no buyers, an empty 204 response can be provided. The information in the bid response can be used to serve an ad, as well as get additional information about the winning bid. According to an embodiment, the bid response can be provided in a JSON format. Further, the bid response can contain the “creative” from the advertiser that the DOOH display 60 will use to serve the advertisement. In particular, the DOOH display 60 retrieves the creative in the “adm” field of the bid response to use as the creative when serving the advertisement. Further, the bid response can also include additional information, such as the cost per mille (CPM) bid for the advertising impression that the advertiser is paying, the bid ID (e.g., unique ID of the bid), as well as other information. According to an embodiment, after the advertisement is played, the DOOH display 60 can provide proof of play to the system 100 by (i) pinging the URLs in the win notification URL (nurl) and the billing URL (burl) fields contained in the bid response and (ii) sending a “proof of play” JSON containing additional information about the advertisement that had been served, e.g., whether or not the creative was served, the bid ID associated with the served advertisement, timestamp of when the serving of the advertisement began, and timestamp of when the serving of the advertisement ended. Further, the bid response can also include an additional URL, e.g., verification URL (vurl), that the DOOH display 60 can ping in order to provide a “proof of play” receipt to the advertiser. In particular, the DOOH display 60 can ping the vurl URL via GET so that the advertiser can get a publisher-side receipt of the advertisement impression that occurred for the DOOH display 60.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

The foregoing detailed description of the present disclosure is to be understood as being in every respect illustrative and exemplary, but not restrictive, and the scope of the present disclosure provided herein is not to be determined solely from the detailed description, but rather from the claims as interpreted according to the full breadth and scope permitted by patent laws. It is to be understood that the embodiments shown and described herein are merely illustrative of the principles addressed by the present disclosure and that various modifications may be implemented by those skilled in the art without departing from the scope and spirit of the present disclosure. Those skilled in the art may implement various other feature combinations without departing from the scope and spirit of the present disclosure. The various functional modules shown are for illustrative purposes only, and may be combined, rearranged and/or otherwise modified.

1. A system for real-time bidding of digital-out-of-home (DOOH) advertising units, the system comprising:
an application programming interface (API) associated with at least one DOOH display, wherein the API is configured to:
receive a bid request from the at least one DOOH display, wherein bid request is associated with an available advertising unit;
provide the bid request to at least one buyer; and
receive a bid response from the at least one buyer, wherein the bid response includes content to be played at the at least one DOOH display.

2. A method for real-time bidding of digital-out-of-home (DOOH) advertising units, the method comprising:
generating, with at least one DOOH display, a bid request, wherein bid request is associated with an available advertising unit;
receiving, with an application programming interface (API) associated with the at least one DOOH display, the bid request;
providing, with the API, the bid request to at least one buyer; and
receiving, with the API, a bid response from the at least one buyer, wherein the bid response includes content to be played at the at least one DOOH display.
